(19) United States
(12) Patent Application Publication
(10) Pub. No.: US 2004/0228329 A1
(43) Pub. Date: Nov. 18, 2004

(54) Method and apparatus for monitoring safe transmission of data packets

(75) Inventor: Joachim Schmidt, Horn-Bad Meinberg (DE)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Phoenix Contact GmbH & Co. KG

(21) Appl. No.: 10/766,980

(22) Filed: Jan. 29, 2004

(30) Foreign Application Priority Data
Jan. 31, 2003 (DE) 03 001 994.7-2415

(51) Int. Cl. H04L 1/00

(52) U.S. Cl. 370/352; 370/473

(57) ABSTRACT

A method and system for monitoring safe transmission of data packets between at least two network subscribers is done in a significantly faster way. Safety-based monitoring of the transmission with respect to incorrectly and correctly transmitted data packets is carried out in real time on the basis of an error rate limit value.

The invention relates to a method and an apparatus for monitoring safe transmission of data packets between at least two network subscribers.

When safety-relevant data is intended to be transmitted via a conventional network, in particular a bus system, then, as a rule, additional measures must be taken in the transmission protocol in order to reduce the residual error rate R(p) of incorrectly transmitted data to correctly transmitted data below a value which is predetermined, for example, by the international IEC Standard 61508, so that the appropriate, stringent safety requirements relating to communication in particular between fail-safe peripheral subscribers and fail-safe CPU subscribers are complied with.

Normally, this is done by adding a data protection value to the data, which is generated on the basis of the payload data and is attached to the respective protocol on the basis of the payload data in a data packet to be transmitted.

On the basis of existing regulations, it is frequently also necessary, on the basis of an error rate p, to verify that the residual error rate R(p) is below the predetermined value. The value 10⁻² must be assumed for p in this case, if no better value is verified. However, data transmissions, for example in accordance with the RS Standard 485/422 normally achieve a better error rate, for example of 10⁻⁵. If this value is intended to be used for verification that a predetermined residual error rate R(p) has not been exceeded, then it must be monitored during operation, that is to say on-line. If the value is exceeded, then a safety-based function must be carried out.

European Patent Application EP-A1-1 147 643 describes a method and a network subscriber, by means of which the error rate p is determined by evaluation of the data protection value.

On the basis of the disclosure in the European Patent Application, the following approach is described for monitoring of a transmission between network subscribers of data packets which each have a data protection value and whose reception may be confirmed by the receiver by means of an acknowledgement. The process of identifying whether a received data packet has been corrupted during transmission is based on a check of the data protection value. The subscriber receiving a transmitted data packet uses the payload data to generate the data protection value once again, which is then compared with the received data protection value. Based on the comparison results, the resultant number of corrupted and uncorrupted data packets or acknowledgements is determined either within a time interval which is or can be predetermined, or over a number, which is or can be predetermined, of transmitted data packets. A safety-based reaction is consequently initiated if the ratio of corrupted to uncorrupted data packets or the number of corrupted data packets reaches or exceeds a threshold value which can be predetermined.

One major disadvantage in this case is, however, in particular that a check such as this can be carried out only after complete reception of transmitted data packets, since not only must the received payload content be completely available in the receiver for renewed generation of the data protection value in each case, but the received data protection value must also be completely available in the receiver in each case for verification of a correctly or incorrectly transmitted data packet.

One object of the invention is therefore to indicate a safe and significantly faster way in which safety-based monitoring of the transmission with respect to incorrectly and correctly transmitted data packets can consequently be carried out significantly closer to real time on the basis of an error rate limit value which is and/or can be predetermined, in particular a residual error and/or bit error rate limit value.

According to the invention, the object is achieved in an extremely surprising manner just by a method having the features of claim 1, an apparatus having the features of claim 9, and/or a network having the features of claim 16.

Advantageous and/or preferred embodiments and developments are the subject matter of the respective dependent claims.

Thus, according to the invention, for monitoring a transmission of data packets between at least two network subscribers, with safety-based monitoring of an error-based limit value which is and/or can be predetermined, being carried out on the transmission medium for response to identified incorrectly transmitted data packets and identified correctly transmitted data packets, it is proposed that, in order to determine incorrectly and correctly transmitted data packets, a data record which is expected by in each case at least one network subscriber be embedded within the payload data, and that this data record be used to determine incorrectly and correctly transmitted data packets.

A major advantage in this case is that the safety-relevant verification of the transmission with respect to compliance with an error-based limit value is carried out just by checking a transmitted data record against the corresponding expected data record, before the respective data packets are completely received by the intended reception subscribers. In consequence, this ensures that, if appropriate, on the one hand, any necessary safety-based reaction is initiated significantly closer to real time and, on the other hand, that any necessary repeated transmission of incorrectly transmitted data packets can be carried out at an earlier stage. Furthermore, the solution according to the invention makes it possible to make considerably more efficient use of the capacity of the network.

A preferred development furthermore provides that a subscriber carrying out the evaluation of identified incorrectly transmitted data packets and identified correctly transmitted data packets does so in each definable time interval, and/or forms the ratio of the respective number of incorrectly transmitted data packets to correctly transmitted data packets.

Furthermore, one particularly preferred development provides that the payload data records which are used for determination are addresses and/or check blocks, for example for checking the transmission path via step chains by replacement of such check blocks.

The invention can thus be used in particular for networks in which the probability of failure of a subscriber and of faulty data check records and/or addresses resulting from this is very much lower than incorrect transmission as a consequence of other disturbances on the transmission medium, for example resulting from EMC interference.

Depending on the application-specific configuration, it is advantageous to carry out the monitoring against a limit value or threshold value which is based on an error rate, residual error rate and/or bit error rate.

Furthermore, particularly in practice, it has been found to be advantageous that efficient, safety-relevant monitoring according to the invention on an application-specific basis intrinsically ensures a high degree of confidence when the monitoring is carried out on the basis of a discrete transmission channel, without any memory, by means of a functional relationship which is based on a Bernoulli distribution, between the probability of receiving an incorrect data record of a specific length and a maximum error rate which can be predetermined.

In one extremely expedient embodiment, the invention furthermore proposes that the product of a maximum error rate, which can be and/or is predetermined, and the number of bits within the expected data record be defined as the limit or threshold value.

Furthermore, the invention advantageously allows the monitoring to be carried out essentially by each subscriber that is intended for this purpose, so that slave subscribers and/or master subscribers can be formed for this purpose, depending on the specific network configuration. In order to carry out central monitoring, one preferred development therefore proposes that information about identified incorrectly and/or correctly transmitted data records be transmitted from the in each case at least one identifying subscriber to the monitoring subscriber. The monitoring according to the invention on the transmission medium thus allows simple network-specific matching, in which case, for example, weighting of identified transmission errors is also provided, based on the respective location of the error identification and the downstream network structure.

A network which is matched according to the invention is preferably in the form of a bus system, in particular a ring bus system, with the invention also covering bus and/or network structures in the form of lines, stars, trees and/or any other types of bus and/or network structures.

In a further preferred refinement, the invention according to the invention has matched networks for operation of automation systems, for building control technology, in the process industry, for passenger transport and/or in the manufacturing industry.

The invention will be described in more detail in the following text using a preferred but exemplary embodiment, and with reference to the drawing.

In the drawing:

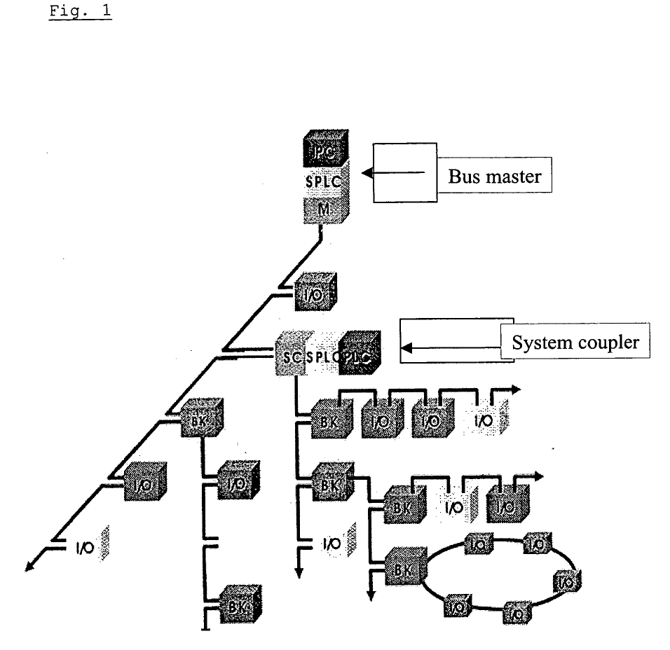

FIG. 1 shows an example of the network structure for use of the invention, and

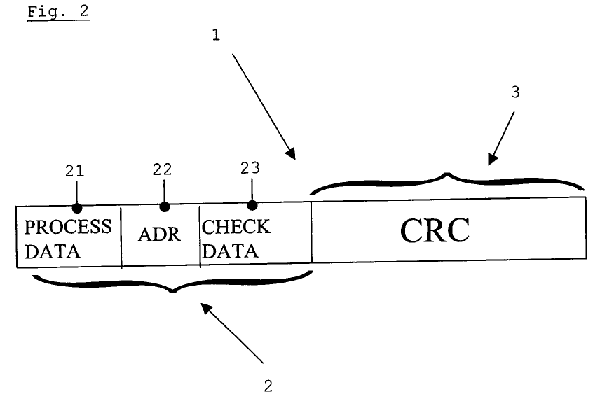

FIG. 2 shows a preferred configuration of a data packet to be transmitted according to the invention.

With reference to FIG. 1, a preferred but exemplary network structure for use of the invention comprises a bus master with corresponding communication drivers and a programmable safety control module, various input/output network subscribers, which are identified by I/O, possibly with integrated, decentralized safety functions, as well as a system coupler and gateways BK. The input/output subscribers are distributed throughout the entire network, independently of system couplers and gateways BK. The overall structure of the network is mixed and has individual bus structures which are coupled to one another and are in the form of rings, lines, stars and trees.

If the processing for the safety monitoring according to the invention is carried out by driver modules in a safety controller which is associated with the master, then the transmission times via the network must also be taken into account in the overall reaction time. Integration of this safety function on the basis of appropriately matched driver modules into safe input/output subscribers in consequence also shortens the processing time for the safety-based reaction, in particular as soon as the system detects that an error-based limit or threshold value has been exceeded during the transmission of data between subscribers.

By way of example, a data packet 1 to be transmitted according to the invention will be described with additional reference to FIG. 2. The data packet 1 has a protocol-specific payload data block 2 and a data block 3, which is attached to it, with a data protection value that is based on the payload data block 2.

Conventionally, a data protection block 3 such as this is generated by transmitting subscribers by matched driver-like means in order to carry out an error checking algorithm on the basis of the data in the payload data block 2, for example in the form of a “cycle redundancy check”, which is known per se. In this case, before the transmission of the payload data 2 in the data packet 1 to be transmitted, an error checking algorithm is used to produce protection data 3 in the form of a CRC value, which is then attached to the payload data 2 in the transmission format.

According to the invention, in addition to pure input/output data and process data 21, the payload data block 2 also includes addresses 22 and/or check records 23 and/or additional data which is safe or not safe. Unlike the data protection block 3, this data is not used for data protection during the transmission of the respective data packet, but makes it possible for the communication subscriber to check the correct operation of the remote subscriber. Provision is therefore made, for example, for the transmission path to be monitored via step chains, by in each case interchanging check records 23.

One major characteristic feature of this additional data 22, 23, overall, is that the receiving and/or observing subscriber, depending on the specific network configuration, has an expectation with regard to the data content. If the remote subscriber or the transmitting subscriber is operating correctly, it therefore knows this data before receiving it.

On the basis that the probability of failure of a subscriber and incorrect data check records 23 and/or addresses 22 resulting from this, is very much less than the incorrect transmission of the data on the transmission medium for other reasons, for example as a result of EMC interference, an error rate p is determined according to the invention, as described in more detail in the following text, on the transmission medium from the ratio of the incorrectly transmitted data check records 23 and/or addresses to the correctly transmitted data check records 23, and/or addresses 22.

It has been found that the probability of failure of a subscriber in all conventional network systems is significantly less than that of incorrect transmission of the data for other reasons.

The example of an approach in the following text to determination of a limit value or threshold value is, for the sake of simplicity, also based on randomly distributed independent errors on a binary, symmetrical, discrete transmission channel without any memory (that is to say on a so-called hard decision channel DMC). On the basis of the further assumption of a Bernoulli distribution, this results in a preferred manner in a relationship between the probability E(p) of observing and/or receiving an incorrectly transmitted data check record 23 of a specific length “l” and an error rate p, which can be and/or is predetermined, on the transmission medium as follows:

$$E ( p ) = {\sum }_{e = l}^{l} ( \begin{matrix}l \\ e\end{matrix} ) {{P}^{e} ( 1 - p )}^{l - e} ,$$

where “e” represents the bit sequential variable up to the specific length “l”.

Thus, for low error rates p:

E(p)=p·l

approximately.

The probability E(p) is thus expediently determined from the ratio of incorrectly transmitted to correctly transmitted payload data records, so that the error rate p becomes:

$$p = \frac{E ( p )}{l}$$

The data protection values 3 which are attached to the payload data block 2 must, in contrast, be ignored during the evaluation, in consequence leading to an earlier reaction, since the reception of just a part of the data packet is sufficient for monitoring.

If, by way of example, a maximum error rate of pₘₐₓ=10⁻⁵ is specified, which must not be exceeded and if, by way of example, the length “l” of the data record to be monitored is equal to 8 bits, this results in a probability E(p) of 8*10⁻⁵.

Thus, on average, only one in 12 500 data records to be monitored may be incorrect. If this is not the case, this then results in the triggering of a safety-relevant reaction which is appropriately preset or results from this.

In addition or alternatively, provision is made for the safety-based reaction to be carried out as a function of incorrectly transmitted data packets, and correctly transmitted data packets, which are identified in each definable time interval.

The safety monitoring according to the invention may in this case be carried out in the master or in slave subscribers depending on the specific configuration of the data records to be monitored and/or the application-based network structures, as mentioned above. Provided that they are not carrying out the actual safety-based monitoring, the receiving and/or observing subscribers then transmit appropriate information about identified incorrectly transmitted payload data records to the monitoring subscriber or subscribers. Simple network-specific matching, for example by weighting of identified transmission errors on the basis of the respective location of the error identification and the downstream network structure and/or taking into account transmission times via the network, is thus ensured.

Furthermore, the invention can preferably be used for networks, in particular bus systems in the field of manufacturing industry, passenger transport, combustion technology, the process industry or in the field of building control technology.

What is claimed is:

1. A method for monitoring a transmission of data packets between at least two network subscribers, comprising:
safety-based monitoring of an error-based limit value, which is and/or can be predetermined, being carried out on a transmission medium for response to identified incorrectly transmitted data packets and identified correctly transmitted data packets;
transmitting a data record within a payload data in each data packet;
wherein, each data record is expected by at least one network subscriber and used to determine whether the data packets have been transmitted incorrectly or correctly.

2. The method as claimed in claim 1, further comprising evaluating identified incorrect data packets and identifying correct data packets in each definable time interval.

3. The method as claimed in claim 1, further comprising forming a ratio of identified incorrect data packets to identified correct data packets.

4. The method as claimed in claim 1, wherein address records and/or check records are used as the expected data records.

5. The method as claimed in claim 1, wherein the monitoring is carried out on the basis of a discrete transmission channel without any memory by means of a functional relationship, which is based on a Bernoulli distribution, between the probability of receiving an incorrect data record of a specific length and a maximum error rate which can be predetermined.

6. The method as claimed in claim 1, wherein the error-based limit value is defined as a product of an error rate, which is or can be predetermined, and a number of bits within the expected data record.

7. The method as claimed in claim 1, wherein the monitoring is performed by at least one slave subscriber and/or at least one master subscriber.

8. The method as claimed in claim 1, wherein, in order to carry out the monitoring process, information is transmitted about identified incorrect and/or correct data packets from at least one waiting subscriber to at least one monitoring subscriber.

9. An apparatus for monitoring a transmission of data packets between at least two network subscribers, comprising
means for safety-based monitoring of an error-based limit value, which can be and/or is predetermined, for response to identified incorrectly transmitted data packets and identified correctly transmitted data packets; and
means for determining incorrectly and correctly transmitted data packets on the basis of an expected data record which is embedded within a payload data of each data packet.

10. The apparatus as claimed in claim 9, wherein the means for safety-based monitoring is designed to carry out an evaluation of identified incorrect data packets and identified correct data packets in each definable time interval.

11. The apparatus as claimed in claim 9, wherein the means for determination responds to address records.

12. The apparatus as claimed in claim 9, wherein the monitoring means is designed for a discrete transmission channel without any memory, and, based on a Bernoulli distribution, form a functional relationship between the probability of receiving an incorrect data record of a specific length and a maximum error rate which can be predetermined.

13. The apparatus as claimed in claim 9, wherein the error-based limit value is defined as a product of an error rate, which is or can be predetermined, and a length of the expected data record.

14. The apparatus as claimed in claim 9, wherein the means for determination is associated with slave subscribers, and the means for monitoring is associated with at least one slave subscriber and/or one master subscriber.

15. The apparatus as claimed in claim 9, wherein the means for determination is associated with network subscribers, which are designed to transmit appropriate information to at least one monitoring subscriber in response to identified incorrect and correct data packets.

16. A network having an apparatus as claimed in claim 9.

17. The network as claimed in claim 16, comprising at least one bus system that is in the form of a ring, line, star or tree.

18. The use of a network as claimed in claim 16 further comprising a function selected from the gourp consisting of: for building control technology, for the process industry, for the manufacturing industry, for passenger transport and for operation of an automation system.

19. The apparatus as claimed in claim 9, wherein the means for safety-based monitoring is designed to form the ratio of identified incorrect data packets to identified correct data packets.

20. The apparatus as claimed in claim 9, wherein the means for determination responds to check records.

21. The apparatus as claimed in claim 9, wherein the means for determination is associated with slave subscribers, and the means for monitoring is associated with at least one master subscriber.
